(19) United States
(12) Patent Application Publication
(10) Pub. No.: US 2014/0374109 A1
(43) Pub. Date: Dec. 25, 2014

(54) Enhanced Carbon Dioxide Capture in a Combined Cycle Plant

(71) Applicants: Robert D. Denton, Bellaire, TX (US); Himanshu Gupta, Lorton, VA (US); Richard A. Huntington, Houston, TX (US); Moses Minta, Missouri City, TX (US); Franklin F. Mittricker, Jamul, CA (US); Loren K. Starcher, Sugar Land, TX (US)

(72) Inventors: Robert D. Denton, Bellaire, TX (US); Himanshu Gupta, Lorton, VA (US); Richard A. Huntington, Houston, TX (US); Moses Minta, Missouri City, TX (US); Franklin F. Mittricker, Jamul, CA (US); Loren K. Starcher, Sugar Land, TX (US)

(21) Appl. No.: 14/301,551

(22) Filed: Jun. 11, 2014

Related U.S. Application Data
(60) Provisional application No. 61/838,080, filed on Jun. 21, 2013.

(51) Int. Cl. B01D 53/62; F01K 17/02; F02C 3/34; E21B 43/16; F02C 7/18

(52) U.S. Cl. CPC B01D 53/62; E21B 43/164; F02C 7/18; F02C 3/34; F01K 17/025
USPC 166/309; 423/230; 60/783; 60/782; 60/39.52; 60/39.182

(57) ABSTRACT

Methods and systems for enhanced carbon dioxide capture in a combined cycle plant are described. A method includes compressing a recycle exhaust gas from a gas turbine system, thereby producing a compressed recycle exhaust gas stream. A purge stream is extracted from the compressed recycle exhaust gas stream. Carbon dioxide is removed from the extracted purge stream using a solid sorbent.

### CROSS REFERENCE TO RELATED APPLICATIONS

This application claims the priority benefit of U.S. Patent Application 61/838,080 filed Jun. 21, 2013 entitled ENHANCED CARBON DIOXIDE CAPTURE IN A COMBINED CYCLE PLANT, the entirety of which is incorporated by reference herein.

### FIELD OF THE INVENTION

Exemplary embodiments of the present techniques relate to low emission power generation in combined-cycle power systems. More particularly, embodiments of the present techniques relate to techniques for enhanced carbon dioxide (CO₂) manufacture and capture in combined-cycle power systems.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

With the growing concern on global climate change and the impact of CO₂ emissions, emphasis has been placed on CO₂ capture from power plants. This concern combined with the implementation of cap-and-trade policies in many countries make reducing CO₂ emissions a priority for these and other countries, as well as for the companies that operate hydrocarbon production systems therein.

Gas turbine combined-cycle power plants are rather efficient and can be operated at relatively low cost when compared to other technologies, such as coal and nuclear. Capturing CO₂ from the exhaust of gas turbine combined-cycle plants, however, can be difficult for several reasons. For instance, there is typically a low concentration of CO₂ in the exhaust compared to the large volume of gas that must be treated. Also, additional cooling is often required before introducing the exhaust to a CO₂ capture system, and the exhaust can become saturated with water after cooling, thereby increasing the reboiler duty in the CO₂ capture system. Other common factors can include the low pressure and large quantities of oxygen frequently contained in the exhaust. All of these factors result in a high cost of CO₂ capture from gas turbine combined-cycle power plants.

Some approaches to lower CO₂ emissions include fuel de-carbonization or post-combustion capture using solvents, such as amines. However, both of these solutions are expensive and reduce power generation efficiency, resulting in lower power production, increased fuel demand, and increased cost of electricity to meet domestic power demand. In particular, the presence of oxygen, SO_{X}, and NO_{X} components makes the use of amine solvent absorption very problematic. Another approach is to use an oxyfuel gas turbine in a combined cycle to capture exhaust heat from the gas turbine Brayton cycle to make steam and produce additional power in a Rankin cycle. However, there are no commercially available gas turbines that can operate in such a cycle, and the power required to produce high purity oxygen significantly reduces the overall efficiency of the process. Several studies have been conducted to compare these processes and show some of the advantages of each approach, as set forth, for example, in BOLLAND, O. et al. (1998) “Removal of CO₂ from Gas Turbine Power Plants: Evaluation of pre- and post-combustion methods,” SINTEF Group, found at http://www.energy.sintef.nO/publ/xergi/98/3/3art-8-engelsk.htm.

Other approaches to lower CO₂ emissions include stoichiometric exhaust gas recirculation, such as in natural gas combined cycles (NGCC). In a conventional NGCC system, only about 40% of the air intake volume is required to provide adequate stoichiometric combustion of the fuel, while the remaining 60% of the air volume serves to moderate the temperature and cool the exhaust gas so as to be suitable for introduction into the succeeding expander, but also disadvantageously generate an excess oxygen byproduct that is difficult to remove. The typical NGCC produces low pressure exhaust gas that requires a fraction of the power produced to extract the CO₂ for sequestration or enhanced oil recovery (EOR), thereby reducing the thermal efficiency of the NGCC. Further, the equipment for the CO₂ extraction is large and expensive, and several stages of compression are required to take the ambient pressure gas to the pressure required for EOR or sequestration. Such limitations are typical of post-combustion carbon capture from low pressure exhaust gas associated with the combustion of other fossil fuels, such as coal.

The foregoing discussion of need in the art is intended to be representative rather than exhaustive. A technology addressing one or more such needs, or some other related shortcoming in the field, would benefit power generation in combined-cycle power systems.

### SUMMARY

An embodiment described herein provides a method for enhanced carbon dioxide capture in a combined cycle plant. The method includes compressing a recycle exhaust gas from a gas turbine system, thereby producing a compressed recycle exhaust gas stream. A purge stream is extracted from the compressed recycle exhaust gas stream. Carbon dioxide is removed from the extracted purge stream using a solid sorbent.

Another embodiment provides a system for enhanced carbon dioxide capture in a combined cycle plant. The system includes a gas turbine system configured to produce a recycle exhaust gas stream as a byproduct of combustion. A compressor is configured to compress the recycle exhaust gas stream, wherein the gas turbine system is further configured to receive the compressed recycle exhaust gas stream and to extract a purge stream from the compressed recycle exhaust gas stream. A carbon dioxide separator is configured to receive the extracted purge stream from the gas turbine system and to remove carbon dioxide from the extracted purge stream using a solid sorbent.

Another embodiment provides a system for enhanced carbon dioxide capture in a combined cycle plant. The system includes a semi-closed Brayton cycle power plant configured to produce a recycle exhaust gas stream as a byproduct of combustion. A heat recovery steam generator (HRSG) is configured to recover heat energy from the recycle exhaust gas stream of a gas turbine system for steam generation and to emit a cooled recycle exhaust gas stream. A compressor is configured to compress the cooled recycle exhaust gas stream, wherein the semi-closed Brayton cycle power plant is further configured to receive the cooled and compressed recycle exhaust gas stream and to extract a purge stream from the cooled and compressed recycle exhaust gas stream. A carbon dioxide separator is configured to receive the extracted purge stream from the semi-closed Brayton cycle power plant and to remove carbon dioxide from the extracted purge stream using a solid sorbent.

### BRIEF DESCRIPTION OF THE DRAWINGS

The advantages of the present techniques are better understood by referring to the following detailed description and the attached drawings, in which:

FIG. 1 is a block diagram of an system for power generation and CO₂ recovery using a combined-cycle arrangement;

FIG. 2 is a simplified process flow diagram of another system for power generation and CO₂ recovery using a combined-cycle arrangement;

FIG. 3 is a block diagram of the CO₂ separator discussed with respect to FIG. 2; and

FIG. 4 is a process flow diagram of a method for enhanced carbon dioxide capture in a combined cycle plant.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Sorption” includes adsorption, chemical adsorption (i.e., chemisorption), absorption, and/or physical adsorption (i.e., physisorption).

“Adsorption” refers to a process whereby certain components of a mixture adhere to the surface of solid bodies that it contacts. This process is generally reversible.

A “combined cycle power plant” or “CCPP” (also referred to herein as a “combined cycle plant”) includes a gas turbine, a steam turbine, a generator, and a heat recovery steam generator (HRSG), and uses both steam and gas turbines to generate power. The gas turbine operates in an open Brayton cycle, and the steam turbine operates in a Rankine cycle. Combined cycle power plants utilize heat from the gas turbine exhaust to boil water in the HRSG to generate steam. The steam generated is utilized to power the steam turbine. After powering the steam turbine, the steam may be condensed and the resulting water returned to the HRSG. The gas turbine and the steam turbine can be utilized to separately power independent generators, or in the alternative, the steam turbine can be combined with the gas turbine to jointly drive a single generator via a common drive shaft. These combined cycle gas/steam power plants generally have higher energy conversion efficiency than Rankine-cycle or steam-only power plants. Currently, simple-cycle plant efficiency can exceed 44% while combined cycle plant efficiency can exceed 60%. The higher combined cycle efficiencies result from synergistic utilization of a combination of the gas turbine with the steam turbine.

A “compressor” is a machine that increases the pressure of a gas by the application of work (compression). Accordingly, a low pressure gas, e.g., about 35 kPa, may be compressed into a high-pressure gas, e.g., about 6,895 kPa, for transmission through a pipeline, injection into a well, or other processes.

The term “gas” is used interchangeably with “vapor,” and means a substance or mixture of substances in the gaseous state as distinguished from the liquid or solid state. Likewise, the term “liquid” means a substance or mixture of substances in the liquid state as distinguished from the gas or solid state.

A “hydrocarbon” is an organic compound that primarily includes the elements hydrogen and carbon, although nitrogen, sulfur, oxygen, metals, or any number of other elements may be present in small amounts. As used herein, hydrocarbons generally refer to organic materials that are harvested from hydrocarbon containing sub-surface rock layers, termed reservoirs. For example, natural gas, oil, and coal are hydrocarbons.

“Hydrocarbon production” or “production” refers to any activity associated with extracting hydrocarbons from a well or other opening. Hydrocarbon production normally refers to any activity conducted in or on the well after the well is completed. Accordingly, hydrocarbon production or extraction includes not only primary hydrocarbon extraction but also secondary and tertiary production techniques, such as injection of gas or liquid for increasing drive pressure, mobilizing the hydrocarbon or treating by, for example, chemicals or hydraulic fracturing of the well bore to promote increased flow, well servicing, well logging, and other well and wellbore treatments.

The term “natural gas” refers to a gas obtained from a crude oil well (associated gas), from a subterranean gas-bearing formation (non-associated gas), or from a coal bed. The composition and pressure of natural gas can vary significantly. A typical natural gas stream contains methane (CH₄) as a significant component. Raw natural gas may also contain ethane (C₂H₆), higher molecular weight hydrocarbons, acid gases (such as carbon dioxide, hydrogen sulfide, carbonyl sulfide, carbon disulfide, and mercaptans), and contaminants such as water, nitrogen, iron sulfide, wax, and crude oil.

“Pressure” is the force exerted per unit area by the gas on the walls of the volume. Pressure can be shown as kilopascals (kPa).

As used herein, a “Rankine cycle power plant” includes a vapor generator, a turbine, a condenser, and a recirculation pump. For example when the vapor is steam, a “Rankine cycle power plant” includes a steam generator, a steam turbine, a steam condenser, and a boiler feedwater pump. The steam generator is often a gas fired boiler that boils water to generate the steam. However, in embodiments, the steam generator may be a geothermal energy source, such as a hot rock layer in a subsurface formation. The steam is used to generate electricity in the steam turbine generator, and the reduced pressure steam is then condensed in the steam condenser. The resulting water is recirculated to the steam generator to complete the loop.

“Reservoir formations” or “reservoirs” are typically pay zones include sandstone, limestone, chalk, coal and some types of shale. Pay zones can vary in thickness from less than one foot (0.3048 m) to hundreds of feet (hundreds of m). The permeability of the reservoir formation provides the potential for production.

“Sequestration” refers to the storing of a gas or fluid that is a by-product of a process rather than discharging the fluid to the atmosphere or open environment. For example, as described herein, carbon dioxide gas formed from the burning or steam reforming of hydrocarbons may be sequestered in underground formations, such as coal beds.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

“Well” or “wellbore” refers to a hole in the subsurface made by drilling or insertion of a conduit into the subsurface. The terms are interchangeable when referring to an opening in the formation. A well may have a substantially circular cross section, or other cross-sectional shapes. Wells may be cased, cased and cemented, or open-hole well, and may be any type, including, but not limited to a producing well, an injection well, an experimental well, and an exploratory well, or the like. A well may be vertical, horizontal, or any angle between vertical and horizontal (a deviated well), for example a vertical well may include a non-vertical component.

### Overview

Embodiments described herein can be used to produce ultra-low emission electric power and CO₂ for enhanced oil recovery (EOR) and/or sequestration applications. In one or more embodiments, a mixture of air and fuel can be stoichiometrically or substantially stoichiometrically combusted and mixed with a stream of recycled exhaust gas. The stream of recycled exhaust gas, generally including products of combustion such as CO₂, can be used as a diluent to control, adjust, or otherwise moderate the temperature of combustion and the exhaust that enters the succeeding expander. As a result of using enriched air, the recycled exhaust gas can have an increased CO₂ content, thereby allowing the expander to operate at even higher expansion ratios for the same inlet and discharge temperatures, thereby producing significantly increased power.

Combustion in commercial gas turbines at stoichiometric conditions or substantially stoichiometric conditions (e.g., “slightly rich” combustion) can prove advantageous in order to eliminate the cost of excess oxygen removal. Still further, slightly lean combustion may further reduce the oxygen content in the exhaust stream. By cooling the exhaust and condensing the water out of the cooled exhaust stream, a relatively high content CO₂ exhaust stream can be produced. While a portion of the recycled exhaust gas can be utilized for temperature moderation in the semi-closed Brayton cycle, a remaining purge stream can interact with a solid sorbent to separate CO₂ therefrom, and the CO₂ can be used for EOR applications. In addition, the remaining purge stream can be used to produce electric power with little or no sulfur oxides (SOx), nitrogen oxides (NOx), and/or CO₂ being emitted to the atmosphere. When the purge stream, or a portion thereof, is routed for electric power production, the result is the production of power in three separate cycles and the manufacturing of additional CO₂.

### Systems for Power Generation and CO₂ Recovery

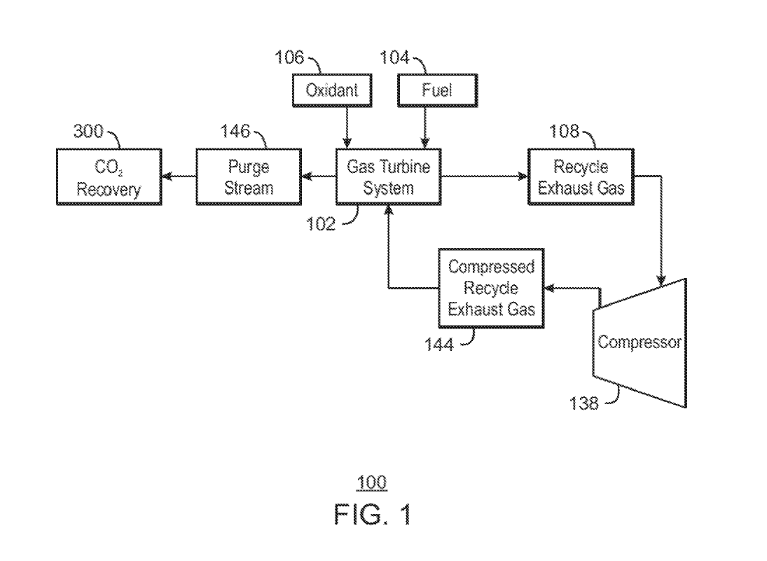

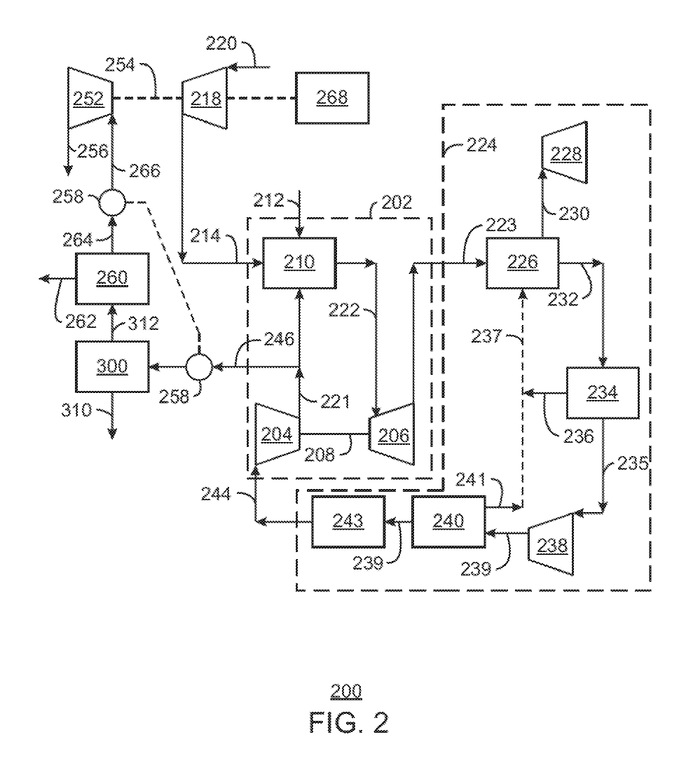

FIG. 1 is a block diagram of a system 100 for power generation and CO₂ recovery using a combined-cycle arrangement. The system 100 includes a gas turbine system 102, which can be characterized as a power-producing semi-closed Brayton cycle. The structure and operation of an exemplary gas turbine system is described in more detail with respect to FIG. 2. The gas turbine system 102 can include a combustion chamber for combusting a fuel 104 mixed with a compressed oxidant 106. The fuel 104 can include any suitable hydrocarbon gas or liquid, such as natural gas, methane, ethane, naphtha, butane, propane, syngas, diesel, kerosene, aviation fuel, coal derived fuel, bio-fuel, oxygenated hydrocarbon feedstock, or any combination thereof. The oxidant 106 can include any suitable gas containing oxygen, such as air, oxygen-rich air, oxygen-depleted air, pure oxygen, or any combination thereof

The gas turbine system 102 produces an exhaust gas 108, which can be sent to any variety of apparatuses and/or facilities in a recycle loop back to the gas turbine system 102. In some embodiments, and as shown in FIG. 1, the recycle loop includes a compressor 138. As opposed to a conventional fan or blower system, the compressor 138 can compress and increase the overall density of the exhaust gas, thereby directing a pressurized or compressed recycle exhaust gas 144 into a main compressor of the gas turbine system 102.

In various embodiments, the compressed recycle exhaust gas 144 is further compressed in the gas turbine system 102, and a purge stream 146 is recovered from the compressed recycle exhaust gas. The purge stream 146 is then treated in a CO₂ separator 300 to capture CO₂ at an elevated pressure. In some embodiments, less than half, e.g., about 40%, of the compressed recycle gas 144 is extracted and diverted to the purge stream 146. The separated CO₂ can be used for sales, used in another process requiring CO₂, and/or further compressed and injected into a terrestrial reservoir for enhanced oil recovery (EOR), sequestration, or another purpose. Because of the stoichiometric or substantially stoichiometric combustion of the fuel 104 combined with the compressor 138, the CO₂ partial pressure in the purge stream 146 can be much higher than in conventional gas turbine exhausts. As a result, carbon capture in the CO₂ separator 300 can be undertaken using low-energy separation processes, such as sorption using a solid sorbent.

It is to be understood that the block diagram of FIG. 1 is not intended to indicate that the system 100 is to include all the components shown in FIG. 1. Further, the system 100 may include any number of additional components not shown in FIG. 1, depending on the details of the specific implementation.

FIG. 2 is a simplified process flow diagram of another system 200 for power generation and CO₂ recovery using a combined-cycle arrangement. The system 200 includes a gas turbine system 202, which may be characterized as a power-producing semi-closed Brayton cycle. The gas turbine system 202 includes a first or main compressor 204 coupled to an expander 206 through a common shaft 208 or other mechanical or electrical power coupling, thereby allowing a portion of the mechanical energy generated by the expander 206 to drive the main compressor 204. The gas turbine system 202 can be a standard gas turbine, where the main compressor 204 and expander 206 form the compressor and expander ends, respectively. However, the main compressor 204 and expander 206 can be individualized components in the gas turbine system 202.

The gas turbine system 202 also includes a combustion chamber 210 for combusting a fuel introduced via line 212 mixed with a compressed oxidant introduced via line 214. As noted above, the fuel in line 212 can include any suitable hydrocarbon gas or liquid, such as natural gas, methane, ethane, naphtha, butane, propane, syngas, diesel, kerosene, aviation fuel, coal derived fuel, bio-fuel, oxygenated hydrocarbon feedstock, or any combination thereof. The compressed oxidant in line 214 is derived from a second or inlet compressor 218. The inlet compressor 218 is fluidly coupled to the combustion chamber 210 and is used to compress a feed oxidant introduced via line 220. In some embodiments, the feed oxidant in line 220 includes any suitable gas-containing oxygen, such as air, oxygen-rich air, oxygen-depleted air, pure oxygen, or any combination thereof. Moreover, in some embodiment, a portion of the compressed oxidant in line 214 bypasses the combustion chamber 210 to cool one or more components of the gas turbine system 202.

As will be described in more detail below, the combustion chamber 210 also receives a compressed recycle exhaust gas in line 221, including an exhaust gas recirculation primarily having CO₂ and nitrogen components. The compressed recycle exhaust gas in line 221 is derived from the main compressor 204 and is used to help facilitate a stoichiometric or substantially stoichiometric combustion of the compressed oxidant in line 214 and fuel in line 212 by moderating the temperature of the combustion products. As can be appreciated, recirculating the exhaust gas can serve to increase the CO₂ concentration in the exhaust gas.

An exhaust gas in line 222 directed to the inlet of the expander 206 is generated as a product of combustion of the fuel in line 212 and the compressed oxidant in line 214, in the presence of the compressed recycle exhaust gas in line 221. In some embodiments, the fuel in line 212 is primarily natural gas, thereby generating a discharge or exhaust gas via line 222 that can include volumetric portions of vaporized water, CO₂, nitrogen, nitrogen oxides (NOx), and sulfur oxides (SOx). In some embodiments, a small portion of unburned fuel in line 212 or other compounds, such as CO, is also present in the exhaust gas in line 222 due to combustion equilibrium limitations. As the exhaust gas in line 222 expands through the expander 206, it generates mechanical power to drive the main compressor 204, for example, through the shaft 208. Other systems may be driven by the mechanical power, such as an electrical generator, compressors, or other facilities. The expansion of the exhaust gas in the expander 206 produces a gaseous exhaust stream 223, which has a heightened CO₂ content than would otherwise result without the influx of the compressed recycle exhaust gas in line 221.

The power generation system 200 also includes an exhaust gas recirculation (EGR) system 224. The EGR system 224 includes a heat recovery steam generator (HRSG) 226, or similar device, fluidly coupled to a steam turbine 228, for example, through line 230. In various embodiments, the combination of the HRSG 226 and the steam turbine 228 are part of a power-producing closed Rankine cycle. In combination with the gas turbine system 202, the HRSG 226 and the steam turbine 228 can form part of a combined-cycle power plant, such as a natural gas combined-cycle (NGCC) plant. The gaseous exhaust stream 223 is introduced to the HRSG 226 in order to generate steam in line 230 and a cooled exhaust gas in line 232. In some embodiments, the steam in line 230 is sent to the steam turbine 228 to generate additional mechanical power. The low pressure steam exiting the steam turbine 228 may be condensed and returned to the HRSG 226 to close the Rankine cycle. The additional mechanical power can be used to power a separate generator. Alternatively, the steam turbine 228 can be coupled, for example, through a gear box, to the shaft 208 of the gas turbine system 202 to supplement the mechanical energy generated by the expander 206. In other embodiments, at least a portion of the steam in line 230 is used in a cyclic steam stimulation system, which injects steam into an oil reservoir to facilitate oil recovery.

The cooled exhaust gas in line 232 is sent back to the main compressor 204 via a recycle loop. As shown in FIG. 2, the recycle loop includes a first cooling unit 234 for cooling the cooled exhaust gas in line 232 and to generate a cooled recycle gas stream 235. The first cooling unit 234 can include, for example, a contact cooler, a trim cooler, an evaporative cooling unit, or any combination thereof. The first cooling unit 234 also removes a portion of any condensed water from the cooled exhaust gas in line 232 via a water dropout stream 236. In some embodiments, the water dropout stream 236 is combined with water from other sources and routed to the HRSG 226 via line 237 to provide additional water for the generation of steam in line 230. In other embodiments, the water recovered via the water dropout stream 236 is used for other downstream applications, such as to provide supplementary heat.

In various embodiments, the cooled recycle gas stream 235 is directed to a boost compressor 238. Cooling the cooled exhaust gas in line 232 in the first cooling unit 234 can reduce the power required to compress the cooled recycle gas stream 235 in the boost compressor 238. As opposed to a conventional fan or blower system, the boost compressor 238 can compress and increase the overall density of the cooled recycle gas stream 235, providing a pressurized recycle gas in line 239, where the pressurized recycle gas in line 239 has an increased mass flow rate for the same volumetric flow. The flow of the pressurized recycle gas in line 239 can be controlled by controlling the discharge pressure of the boost compressor 238. This can prove advantageous since the main compressor 204 can be volume-flow limited, and directing more mass flow through the main compressor 204 can result in higher discharge pressures, thereby translating into higher pressure ratios across the expander 206. Higher pressure ratios generated across the expander 206 can allow for higher inlet temperatures and, therefore, an increase in power and efficiency in the expander 206. Moreover, because at least some of the pressurized recycle gas 239 is eventually recirculated to the boost compressor 238, an inlet pressure of the boost compressor 238 can be maintained above atmospheric pressure, and the discharge pressure of the boost compressor 238 can be kept below design limits.

Since the inlet pressure of the main compressor 204 is a function of the inlet temperature, a cooler inlet temperature will demand less power to operate the main compressor 204 for the same mass flow. Consequently, the pressurized recycle gas in line 239 can optionally be directed to a second cooling unit 240. The second cooling unit 240 can include, for example, a direct contact cooler, a trim cooler, an evaporative cooling unit, or any combination thereof. In some embodiments, the second cooling unit 240 serves as an after-cooler for removing at least a portion of the heat of compression generated by the boost compressor 238 on the pressurized recycle gas in line 239. The second cooling unit 240 can also extract additional condensed water via a water dropout stream 241. In one or more embodiments, the water dropout streams 236, 241 can converge into stream 237, and may or may not be routed to the HRSG 226 to generate additional steam via line 230 therein. After undergoing cooling in the second cooling unit 240, the pressurized recycle gas in line 239 is directed to a third cooling unit 243. Moreover, while only first, second, and third cooling units 234, 240, and 243 are depicted herein, it will be appreciated that any number of cooling units can be employed to suit a variety of applications, without departing from the scope of the disclosure. For example, a single cooling unit may be implemented in some embodiments.

The third cooling unit 243, like the first and second cooling units, can be an evaporative cooling unit for further reducing the temperature of the pressurized recycle gas in line 239 before being injected into the main compressor 204 via line 244. In other embodiments, however, one or more of the cooling units 234, 240, and 243 can be a mechanical refrigeration system without departing from the scope of the disclosure.

The main compressor 204 compresses the pressurized recycle gas in line 239 received from the third cooling unit 243 to a pressure nominally at or above the combustion chamber pressure, thereby generating the compressed recycle gas in line 221. As can be appreciated, cooling the pressurized recycle gas in line 239 in both the second and third cooling units 240 and 243 after compression in the boost compressor 238 can allow for an increased volumetric mass flow of exhaust gas into the main compressor 204. Consequently, this can reduce the amount of power required to compress the pressurized recycle gas in line 239 to a predetermined pressure.

While FIG. 2 illustrates three cooling units and a boost compressor in the exhaust gas recirculation loop, it should be understood that each of these units is used to reduce the mass flow rate in the cooled exhaust gas in line 232. As described above, a reduction in mass flow rate, such as by the boost compressor, together with a reduction in temperature is advantageous.

In various embodiments, a purge stream 246 is recovered from the compressed recycle gas in line 221 and subsequently treated in a CO₂ separator 300 to capture CO₂ at an elevated pressure via line 310. In some embodiments, less than half, e.g., about 40%, of the compressed recycle gas in line 221 is extracted and diverted to the purge stream 246. The separated CO₂ in line 310 can be used for sales, used in another process requiring CO₂, and/or further compressed and injected into a terrestrial reservoir for enhanced oil recovery (EOR), sequestration, or another purpose. Because of the stoichiometric or substantially stoichiometric combustion of the fuel in line 212 combined with the apparatuses on the exhaust gas recirculation system 224, the CO₂ partial pressure in the purge stream 246 can be much higher than in conventional gas turbine exhausts. As a result, carbon capture in the CO₂ separator 300 can be undertaken using low-energy separation processes, such as sorption using a solid sorbent.

A residual stream 312, essentially depleted of CO₂ and consisting primarily of nitrogen, is also derived from the CO₂ separator 300. In some embodiments, the residual stream 312 is vented to the atmosphere. However, in other embodiments, the residual stream 312 is introduced to a gas expander 252 to provide power and an expanded depressurized gas via line 256. The expander 252 can be, for example, a power-producing nitrogen expander. As depicted, the gas expander 252 can be optionally coupled to the inlet compressor 218 through a common shaft 254 or other mechanical or electrical power coupling, thereby allowing a portion of the power generated by the gas expander 252 to drive the inlet compressor 218. In other embodiments, however, the gas expander 252 is used to provide power to other applications, and not directly coupled to the stoichiometric compressor 218. For example, there may be a substantial mismatch between the power generated by the expander 252 and the requirements of the compressor 218. In such cases, the expander 252 may drive a smaller compressor that demands less power. Alternatively, the expander may drive a larger compressor that demands more power.

An expanded depressurized gas in line 256, primarily consisting of dry nitrogen gas, is discharged from the gas expander 252. The resultant dry nitrogen can help facilitate the evaporation and cooling of a stream of water in the third cooling unit 243 to thereby cool the pressurized recycle gas in line 239. Alternatively, or in addition, the expanded depressurized gas in line 256 can be used in a standalone stoichiometric combustor (not shown) for a standalone stoichiometric combustion exhaust gas recirculation application. In some embodiments, the combination of the gas expander 252, the inlet compressor 218, and the CO₂ separator 300 is characterized as an open Brayton cycle, or a third power-producing component of the system 200.

The system 200 described herein, particularly with the added exhaust gas exhaust pressurization from the boost compressor 238, can be implemented to achieve a higher concentration of CO₂ in the exhaust gas, thereby allowing for more effective CO₂ separation and capture. For instance, embodiments described herein can effectively increase the concentration of CO₂ in the exhaust gas exhaust stream to about 10 vol % with a pure methane fuel or even higher with a richer gas. To accomplish this, the combustion chamber 210 stoichiometrically combusts the incoming mixture of fuel in line 212 and compressed oxidant in line 214. In order to moderate the temperature of the stoichiometric combustion to meet expander 206 inlet temperature and component cooling requirements, a portion of the exhaust gas derived from the compressed recycle gas in line 221 can be injected into the combustion chamber 210 as a diluent. In addition, or alternatively, a portion of the compressed recycle gas in line 221 can be diverted to cool one or more components of the gas turbine system 202. As compared to the conventional practice of introducing excess air or oxidant in the combustion chamber to moderate temperature, the use of the recycled exhaust gas significantly reduces the amount of oxygen exiting the combustion chamber 210. Thus, embodiments of the disclosure can essentially eliminate any excess oxygen from the exhaust gas while simultaneously increasing its CO₂ composition. As such, the gaseous exhaust stream 223 can have less than about 3.0 vol % oxygen, or less than about 1.0 vol % oxygen, or less than about 0.1 vol % oxygen, or even less than about 0.001 vol % oxygen.

The specifics of an exemplary operation of the system 200 will now be discussed. As will be appreciated, specific temperatures and pressures achieved or experienced in the various components of any of the embodiments described herein can change depending on, among other factors, the purity of the oxidant used and/or the specific makes and/or models of expanders, compressors, coolers, or the like. Accordingly, it will be appreciated that the particular data described herein is for illustrative purposes only and should not be construed as the only interpretation thereof. For example, in some embodiments, the inlet compressor 218 provides compressed oxidant in line 214 at pressures ranging between about 1,931 kPa and about 2,068 kPa. Also contemplated herein, however, is aeroderivative gas turbine technology, which can produce and consume pressures of up to about 5,171 kPa or higher.

The main compressor 204 can recycle and compress recycled exhaust gas into the compressed recycle gas in line 221 at a pressure nominally above or at the combustion chamber 210 pressure, and use a portion of that recycled exhaust gas as a diluent in the combustion chamber 210. Because the amount of diluent used in the combustion chamber 210 can depend on the purity of the oxidant used for stoichiometric combustion or the particular model or design of the expander 206, a ring of thermocouples and/or oxygen sensors (not shown) can be associated with the combustion chamber and/or the expander. For example, thermocouples and/or oxygen sensors may be disposed on the outlet of the combustion chamber 210, on the inlet to the expander 206 and/or on the outlet of the expander 206. In operation, the thermocouples and sensors can be used to determine the compositions and/or temperatures of one or more streams for use in determining the volume of exhaust gas to be used as diluent to cool the products of combustion to a suitable expander inlet temperature. Additionally or alternatively, the thermocouples and sensors may be used to determine the amount of oxidant to be injected into the combustion chamber 210. Thus, in response to the heat requirements detected by the thermocouples and the oxygen levels detected by the oxygen sensors, the volumetric mass flow of compressed recycle gas in line 221 and/or compressed oxidant in line 214 can be manipulated or controlled to match the demand. The volumetric mass flow rates may be controlled through any suitable flow control systems, which may be in electrical communication with the thermocouples and/or oxygen sensors.

In some embodiments, a pressure drop of about 83−90 kPa is experienced across the combustion chamber 210 during stoichiometric or substantially stoichiometric combustion. Combustion of the fuel in line 212 and the compressed oxidant in line 214 can generate temperatures ranging from about 1093 degrees Celsius (° C.) to about 1649° C. and pressures ranging from about 1,724 kPa to about 2,068 kPa. Because of the increased mass flow and higher specific heat capacity of the CO₂-rich exhaust gas derived from the compressed recycle gas in line 221, a higher pressure ratio can be achieved across the expander 206, thereby allowing for higher inlet temperatures and increased expander 206 power.

The gaseous exhaust stream 223 exiting the expander 206 can exhibit pressures at or near ambient pressure. In some embodiments, the gaseous exhaust stream 223 has a pressure of about 90−117 kPa. The temperature of the gaseous exhaust stream 223 can be about 663° C. to about 691° C. before passing through the HRSG 226 to generate steam in line 230 and a cooled exhaust gas in line 232.

The next several paragraphs describe the exemplary implementation shown in FIG. 2. As described above, FIG. 2 illustrates multiple apparatuses in association with the exhaust gas recycle loop in the interest of illustrating the various possible combinations. However, it should be understood that the invention described herein does not require a combination of all such elements and is defined by the following claims and/or the claims of any subsequent applications claiming priority to this application. For example, while multiple cooling units are illustrated in FIG. 2, it should be understood that a direct contact cooling unit utilizing coolant associated with the nitrogen vent stream, e.g., cooling unit 243, may provide sufficient cooling by virtue of the single cooling unit. In some implementations, the cooling unit 243 may provide sufficient cooling to provide the advantages of the booster compressor as well.

In some embodiments, the cooling unit 234 reduces the temperature of the cooled exhaust gas in line 232, thereby generating the cooled recycle gas stream 235 having a temperature between about 0° C. and about 49° C. As can be appreciated, such temperatures can fluctuate depending primarily on wet bulb temperatures during specific seasons in specific locations around the globe.

In various embodiments, the boost compressor 238 elevates the pressure of the cooled recycle gas stream 235 to a pressure ranging from about 117 kPa to about 145 kPa. The added compression of the boost compressor 238 is an additional method, in addition to the use of cooling units, to provide a recycled exhaust gas to the main compressor 204 having a higher density and increased mass flow, thereby allowing for a substantially higher discharge pressure while maintaining the same or similar pressure ratio. In order to further increase the density and mass flow of the exhaust gas, the pressurized recycle gas in line 239 discharged from the boost compressor 238 can then be further cooled in the second and third cooling units 240 and 243. In some embodiments, the second cooling unit 240 reduces the temperature of the pressurized recycle gas in line 239 to about 41° C. before being directed to the third cooling unit 243. In addition, in some embodiments, the third cooling unit 243 reduces the temperature of the pressurized recycle gas in line 239 to temperatures below about 38° C.

In various embodiments, the temperature of the compressed recycle gas in line 221 discharged from the main compressor 204 and the purge stream 246 is about 427° C., with a pressure of about 1,931 kPa. As can be appreciated, the addition of the boost compressor 238 and/or the one or more cooling units can increase the CO₂ purge pressure of the purge stream 246, which can lead to improved solid sorbent performance in the CO₂ separator 300 due to the higher CO₂ partial pressure. In some embodiments, the sorption process in the CO₂ separator 300 is improved by cooling the purge stream 246. To achieve this, the purge stream 246 is channeled through a heat exchanger 258, such as a cross-exchange heat exchanger. Extracting CO₂ from the purge stream 246 in the CO₂ separator 300 leaves a saturated, nitrogen-rich residual stream 312 at or near the elevated pressure of the purge stream 246 and at a temperature of about 66° C. The heat exchanger 258 may be coupled with the residual stream 312 as illustrated or with other streams or facilities in the integrated system. When coupled with the residual stream 312, the heat exchanger 258 heats the residual stream to increase the power obtainable from the gas expander 252.

As stated above, the nitrogen in the residual stream 312 as subsequently expanded into expanded depressurized gas in line 256 can be subsequently used to evaporate and cool water. The cooled water may then be used to cool the pressurized recycle gas in line 239 injected into the third cooling unit 243, which may be the only cooling unit in the exhaust gas recycle loop. As an evaporative cooling catalyst, the nitrogen is to be as dry as possible. Accordingly, the residual stream 312 is directed through a fourth cooling unit 260 or condenser that is used to cool the residual stream 312, thereby condensing and extracting an additional portion of water via line 262. In some embodiments, the fourth cooling unit 260 is a direct contact cooler cooled with standard cooling water in order to reduce the temperature of the residual stream 312 to about 41° C. In other embodiments, the fourth cooling unit 260 is a trim cooler or straight heat exchanger. The resultant water content of the residual stream 312 can be about 0.1 wt % to about 0.5 wt %. In some embodiments, the water removed via stream 262 is routed to the HRSG 226 to create additional steam. In other embodiments, the water in stream 262 is treated and used as agricultural water or demineralized water.

A dry nitrogen gas is discharged from the fourth cooling unit 260 via stream 264. In some embodiments, the heat energy associated with cooling the purge stream 246 is extracted via the heat exchanger 258, which can be fluidly coupled to the dry nitrogen gas stream 264 and can be used to re-heat the nitrogen gas prior to expansion. Reheating the nitrogen gas can generate a dry heated nitrogen stream 266 having a temperature ranging from about 399° C. to about 421° C., and a pressure ranging from about 1,862 kPa to about 1,931 kPa. In embodiments where the heat exchanger 258 is a gas/gas heat exchanger, there will be a “pinch point” temperature difference realized between the purge stream 246 and the dry nitrogen gas stream 264, wherein the temperature dry nitrogen gas stream 264 is less than the temperature of the purge stream 246.

In various embodiments, the dry heated nitrogen stream 266 is then expanded through the gas expander 252 and optionally used to power the stoichiometric inlet compressor 218, as described above. Accordingly, cross-exchanging the heat in the heat exchanger 258 may allow for the capture of a substantial amount of compression energy derived from the main compressor 204 and, thus, the maximization of the power extracted from the gas expander 252. In some embodiments, the gas expander 252 discharges a nitrogen expanded depressurized gas in line 256 at or near atmospheric pressure and having a temperature ranging from about 38° C. to about 41° C. As can be appreciated, the resulting temperature of the nitrogen expanded depressurized gas in line 256 can generally be a function of the composition of the exhaust gas, the temperature purge gas 246, and the pressure of the dry nitrogen gas stream 264 before being expanded in the gas expander 252.

Since a measurable amount of water can be removed from the residual stream 312 in the fourth cooling unit 260, a decreased amount of mass flow will be subsequently expanded in the gas expander 252, thereby resulting in reduced power production. Consequently, during start-up of the system 200 and during normal operation when the gas expander 252 is unable to supply all the power for operating the inlet compressor 218, at least one motor 268, such as an electric motor, can be used synergistically with the gas expander 252. For instance, the motor 268 can be sensibly sized such that during normal operation of the system 400, the motor 268 can be used to supply the power short-fall from the gas expander 252. Additionally or alternatively, the motor 268 may be used as a motor/generator to be convertible to a generator when the gas turbine 252 produces more power than is used by the inlet compressor 218.

Illustrative systems and methods of expanding the nitrogen gas in the residual stream 312, and variations thereof, can be found in International Patent Application Publication Number WO 2012/003077, entitled “Low Emission Triple-Cycle Power Generation Systems and Methods,” filed Jun. 9, 2011, the contents of which are hereby incorporated by reference to the extent not inconsistent with the present disclosure.

In addition to (or as an alternative to) using the residual stream 312 to produce electric power and/or to power the stoichiometric inlet compressor 218, the residual stream 312 may be used to maintain pressure in the power generation system 200. To facilitate pressure maintenance, the residual stream 312 may first be fed to a compressor (not shown) to increase pressure of the stream.

It is to be understood that the block diagram of FIG. 2 is not intended to indicate that the system 200 is to include all the components shown in FIG. 2. Further, the system 200 may include any number of additional components not shown in FIG. 2, depending on the details of the specific implementation. For example, the system 200 of FIG. 2 can include any number of additional valves, gear boxes, sensors, control systems, generators, condensers, or the like.

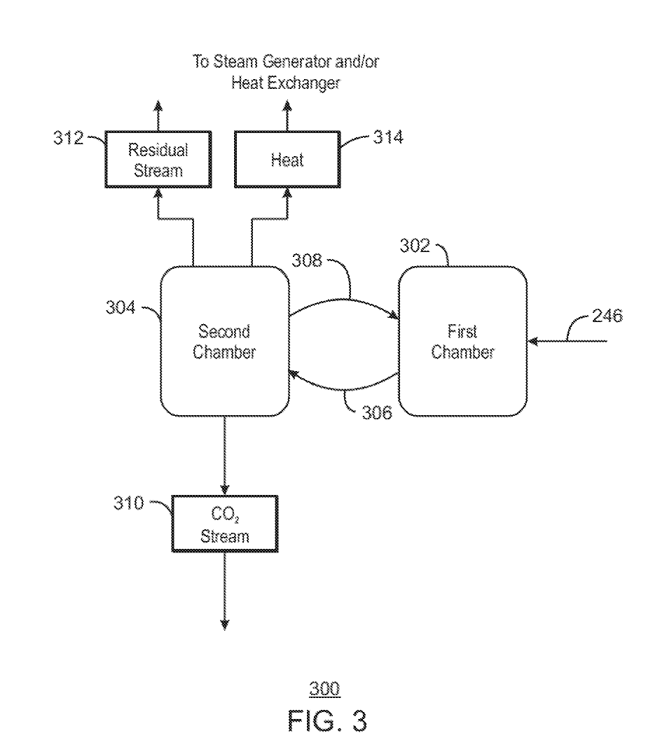

FIG. 3 is a block diagram of the CO₂ separator 300 discussed with respect to FIG. 2. As discussed above, in the CO₂ separator 300, the purge stream 246 interacts with a solid sorbent to capture CO₂ in a sorption process in which the solid sorbent adsorbs or chemisorbs the CO₂ in the purge stream 246. The solid sorbent is re-generated to separate the CO₂ into line 250 for sequestration and/or other purposes.

In various embodiments, the CO₂ separator 300 includes a first chamber 302 and a second chamber 304 that hold a solid sorbent. The purge stream 246 (after optionally being channeled through the heat exchanger 258) is sent through the first chamber 302. Within the first chamber 302, the solid sorbent in the chamber reacts with and separates the CO₂ from the purge stream 246. The CO₂ separator 300 includes a controller (not shown) that can control pressure and/or temperature conditions in the first chamber 302 to favor adsorption and/or chemisorption of carbon dioxide in the purge stream 246 by the solid sorbent. For example, the pressure and/or temperature conditions may be controlled to favor a carbonation reaction between the purge stream 246 and the solid sorbent. The reaction products of the sorption process (also referred to herein as the carbon dioxide-enriched solid sorbent) may include carbonates and/or bicarbonates. The reaction products are passed via line 306 to the second chamber 304, where they are re-generated.

The controller of the carbon dioxide separator 300 can control temperature and/or pressure conditions in the second chamber 304 to facilitate re-generation of the CO₂-enriched solid sorbent. For example, CO₂-enriched solid sorbent can be re-generated through a change in temperature and/or a change in partial pressure of CO₂ in the second chamber 304, e.g., through the use of steam. The gaseous exhaust stream 223 and/or a coil in the HRSG 226 can serve as a source of heat for the re-generation process. During the re-generation process, CO₂ gas is discharged in a nearly-pure stream in line 310 and the residual stream 312 is discharged to a vent or used for other purposes, as described above. The re-generated sorbent material can then be returned to the first chamber 302 via line 308 to be used again to capture more CO₂.

The sorption process may be effected over a wide range of temperatures, e.g., about 100° C. to about 900° C. In addition, the sorption process is exothermic, and heat 314 generated by the process may be used in any number of ways. For example, the heat 314 can be conveyed to the heat exchanger 258 to increase the temperature of the residual stream 312 and thereby increase power obtainable from the gas expander 252. Alternatively, or in addition, the heat may be conveyed to a steam generator, e.g., the HRSG 226, to make additional steam and thereby generate additional electricity.

The solid sorbent may be any suitable type of material. Important factors for selection of the solid sorbent include costs of material, the ability to re-generate the sorbent, ease of re-generation, and the like. Thus, the solid sorbent used in the first chamber 302 may include, but is not limited to, a calcium oxide/hydroxide; a lithium-based sorbent, such as lithium silicate and/or lithium zirconate; sodium oxide/hydroxide; sodium carbonate; potassium oxide/hydroxide; potassium carbonate; or any combination of the foregoing materials. In some embodiments, the solid sorbent is supported by a support substrate made of a suitable support material such as hydrotalcite or alumina. Use of solid sorbents can significantly reduce the amount of energy required to capture and release CO₂ relative to other CO₂ capture technologies.

It is to be understood that the block diagram of FIG. 3 is not intended to indicate that the CO₂ separator 300 is to include all the components shown in FIG. 3. Further, the CO₂ separator 300 may include any number of additional components not shown in FIG. 3, depending on the details of the specific implementation.

### Method for Power Generation and CO₂ Recovery

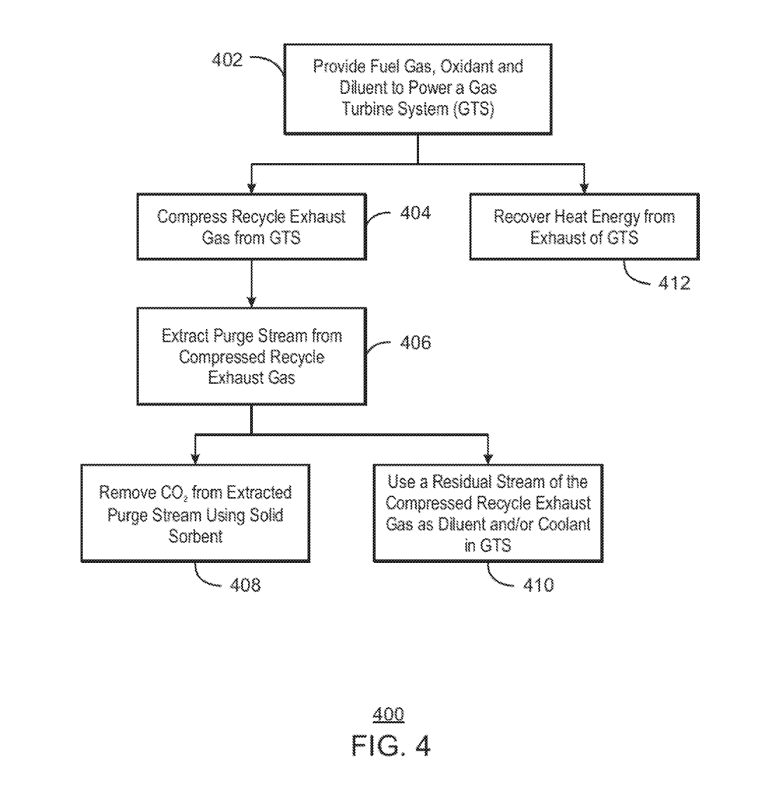

FIG. 4 is a process flow diagram of a method 400 for enhanced carbon dioxide capture in a combined cycle plant. The method 400 begins at block 402, at which a fuel gas and oxidant are used to power a gas turbine system (GTS) in a combined cycle plant. The fuel gas and oxidant are mixed with a diluent to provide cooling and lower the amount of oxidant used.

At block 404, a recycle exhaust gas from the GTS is compressed. In various embodiments, the recycle exhaust gas is compressed to a pressure level above atmospheric pressure.

At block, 406, a purge stream is extracted from the compressed recycle exhaust gas. A volume of the purge stream extracted from the compressed recycle exhaust gas stream may be less than half of the volume of the compressed recycle exhaust gas stream.

At block 408, the extracted purge stream reacts with a solid sorbent to remove carbon dioxide from the purge stream. The solid sorbent may include calcium, lithium, sodium, potassium, or any combination thereof. The reaction of the extracted purge stream with the solid sorbent may include adsorbing and/or chemisorbing the carbon dioxide within the extracted purge stream with the solid sorbent. Further, the solid sorbent may be re-generated by changing temperature and/or pressure in a chamber that holds the solid sorbent.

In various embodiments, removal of the carbon dioxide from the extracted purge stream is performed under pressure and/or temperature conditions that favor a carbonation reaction between the extracted purge stream and the solid sorbent. For example, removal of the carbon dioxide from the extracted purge stream may be performed at a temperature ranging from about 100° C. to about 900° C.

While carbon dioxide is removed from the extracted purge stream, a residual stream of the compressed recycle exhaust gas is fed to a combustor of the GTS as a diluent and coolant at block 410. Moreover, while the recycle exhaust gas is compressed and a purge stream is extracted for removal of carbon dioxide, heat energy may be recovered from the exhaust of the GTS at block 412.

It is to be understood that the process flow diagram of FIG. 4 is not intended to indicate that the blocks of the method 400 are to be executed in any particular order, or that all of the blocks are to be included in every case. Further, any number of additional blocks may be included within the method 400, depending on the details of the specific implementation.

### Embodiments

Embodiments of the techniques may include any combinations of the methods and systems shown in the following numbered paragraphs. This is not to be considered a complete listing of all possible embodiments, as any number of variations can be envisioned from the description herein.

1. A method for enhanced carbon dioxide capture in a combined cycle plant, including:

compressing a recycle exhaust gas from a gas turbine system, thereby producing a compressed recycle exhaust gas stream;

extracting a purge stream from the compressed recycle exhaust gas stream; and

removing carbon dioxide from the extracted purge stream using a solid sorbent.

2. The method of paragraph 1, including using the compressed recycle exhaust gas stream to cool a combustor in the gas turbine system.
3. The method of paragraph 2, including compressing a gaseous fuel for use in the combustor.
4. The method of any one of paragraphs 1, 2, or 3, including recovering heat energy from the recycle exhaust gas stream to generate steam in a heat recovery steam generator (HRSG).
5. The method of paragraph 4, including using the generated steam to generate power or facilitate oil recovery in a cyclic steam stimulation system, or both.
6. The method of paragraph 4, including re-generating the solid sorbent using heat from the HRSG.
7. The method of any one of the previous paragraphs, including using a residual stream of the compressed recycle exhaust gas stream as a diluent in a combustor of the gas turbine system or a coolant for at least a portion of an expander of the gas turbine system, or both.
8. The method of any one of the previous paragraphs, wherein a volume of the purge stream extracted from the compressed recycle exhaust gas stream is less than half of a volume of the compressed recycle exhaust gas stream.
9. The method of any one of the previous paragraphs, wherein the recycle exhaust gas is compressed to a pressure level above atmospheric pressure.
10. The method of any one of the previous paragraphs, wherein removing carbon dioxide from the extracted purge stream includes adsorbing and/or chemisorbing the carbon dioxide with the solid sorbent.
11. The method of any one of the previous paragraphs, wherein removing carbon dioxide from the extracted purge stream using a solid sorbent includes re-generating the solid sorbent by changing temperature and/or pressure in a chamber that holds the solid sorbent.
12. The method of any one of the previous paragraphs, wherein removing carbon dioxide from the extracted purge stream is performed under pressure and/or temperature conditions that favor a carbonation reaction between the extracted purge stream and the solid sorbent.
13. The method of any one of the previous paragraphs, wherein the solid sorbent used to remove carbon dioxide from the extracted purge stream includes calcium, lithium, sodium, or potassium, or any combinations thereof.
14. The method of any one of the previous paragraphs, wherein removing the carbon dioxide from the extracted purge stream is performed at a temperature between a range of about 100 degrees Celsius to about 900 degrees Celsius.
15. The method of any one of the previous paragraphs, wherein removing the carbon dioxide from the extracted purge stream includes performance of an exothermic process, the method further including using heat generated by the exothermic process to generate steam.
16. The method of any one of the previous paragraphs, wherein removing the carbon dioxide from the extracted purge stream includes performance of an exothermic process, the method further including using heat generated by the exothermic process to increase a temperature of a residual stream, substantially depleted of carbon dioxide, of the extracted purge stream.
17. The method of any one of the previous paragraphs, including injecting the removed carbon dioxide into an oil reservoir to enhance recovery of oil from the oil reservoir.
18. The method of any one of the previous paragraphs, including, after removing the carbon dioxide, using a residual stream, substantially depleted of carbon dioxide, of the extracted purge stream for pressure maintenance in the combined cycle plant.
19. The method of any one of the previous paragraphs, including, after removing the carbon dioxide, using a residual stream, substantially depleted of carbon dioxide, of the extracted purge stream in a standalone stoichiometric combustion exhaust gas recirculation application.
20. A system for enhanced carbon dioxide capture in a combined cycle plant, including:

a gas turbine system configured to produce a recycle exhaust gas stream as a byproduct of combustion;

a compressor configured to compress the recycle exhaust gas stream, wherein the gas turbine system is further configured to receive the compressed recycle exhaust gas stream and to extract a purge stream from the compressed recycle exhaust gas stream; and

a carbon dioxide separator configured to receive the extracted purge stream from the gas turbine system and to remove carbon dioxide from the extracted purge stream using a solid sorbent.

21. The system of paragraph 20, including:

a heat recovery steam generator (HRSG) configured to recover heat energy from the recycle exhaust gas stream of the gas turbine system to generate steam; and

a steam turbine that is fluidly coupled to the HRSG to receive the generated steam, wherein the steam turbine is configured to generate power with the received steam.

22. The system of paragraph 21, wherein the carbon dioxide separator is coupled to receive heat from the HRSG and is configured to use the received heat to re-generate the solid sorbent.
23. The system of any one of paragraphs 20-22, wherein the carbon dioxide separator includes a first chamber configured to hold the solid sorbent, the carbon dioxide separator being configured to control temperature and/or pressure conditions in the first chamber to favor adsorption and/or chemisorption of carbon dioxide by the solid sorbent.
24. The system of paragraph 23, wherein the carbon dioxide separator includes a second chamber configured to hold carbon dioxide-enriched solid sorbent, the carbon dioxide separator being configured to control temperature and/or pressure conditions in the second chamber to re-generate the carbon dioxide-enriched solid sorbent.
25. The system of any one of paragraphs 20-24, wherein the solid sorbent used to remove the carbon dioxide from the extracted purge stream includes calcium, lithium, sodium, or potassium, or any combinations thereof.
26. The system of any one of paragraphs 20-25, including a steam generator, wherein the carbon dioxide separator generates heat as part of the process of removing carbon dioxide from the extracted purge stream and the steam generator is configured to use the generated heat to generate steam.
27. The system of any one of paragraphs 20-26, including a heat exchanger, wherein the carbon dioxide separator generates heat as part of the process of removing carbon dioxide from the extracted purge stream and the heat exchanger is configured to use the generated heat to increase a temperature of a residual stream of the extracted purge stream in which the carbon dioxide has been substantially removed.
28. The system of any one of paragraphs 20-27, including another compressor configured to use a residual stream, substantially depleted of carbon dioxide, of the extracted purge stream for pressure maintenance in the combined cycle plant.
29. The system of any one of paragraphs 20-28, including a standalone stoichiometric combustor configured to use a residual stream, substantially depleted of carbon dioxide, of the extracted purge stream for a standalone stoichiometric combustion exhaust gas recirculation application.
30. A system for enhanced carbon dioxide capture in a combined cycle plant, including:

a semi-closed Brayton cycle power plant configured to produce a recycle exhaust gas stream as a byproduct of combustion;

a heat recovery steam generator (HRSG) configured to recover heat energy from the recycle exhaust gas stream of a gas turbine system for steam generation and to emit a cooled recycle exhaust gas stream;

a compressor configured to compress the cooled recycle exhaust gas stream, wherein the semi-closed Brayton cycle power plant is further configured to receive the cooled and compressed recycle exhaust gas stream and to extract a purge stream from the cooled and compressed recycle exhaust gas stream; and

a carbon dioxide separator configured to receive the extracted purge stream from the semi-closed Brayton cycle power plant and to remove carbon dioxide from the extracted purge stream using a solid sorbent.

31. The system of paragraph 30, wherein the carbon dioxide separator is coupled to receive heat from the HRSG and is configured to use the received heat to re-generate the solid sorbent.

32. The system of either one of paragraphs 30 or 31, wherein the carbon dioxide separator includes:

a first chamber configured to hold the solid sorbent, the carbon dioxide separator being configured to control temperature and/or pressure conditions in the first chamber to favor adsorption and/or chemisorption of carbon dioxide by the solid sorbent; and

a second chamber configured to hold carbon dioxide-enriched solid sorbent, the carbon dioxide separator being configured to control temperature and/or pressure conditions in the second chamber to re-generate the carbon dioxide-enriched solid sorbent.

33. The system of any one of paragraphs 30-32, wherein the carbon dioxide separator generates heat as part of the process of removing carbon dioxide from the extracted purge stream, and wherein the system is configured to use the generated heat to generate steam and/or to increase a temperature of a residual stream of the extracted purge stream in which the carbon dioxide has been substantially removed.

While the present techniques may be susceptible to various modifications and alternative forms, the exemplary embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A method for enhanced carbon dioxide capture in a combined cycle plant, comprising:
compressing a recycle exhaust gas from a gas turbine system, thereby producing a compressed recycle exhaust gas stream;
extracting a purge stream from the compressed recycle exhaust gas stream; and
removing carbon dioxide from the extracted purge stream using a solid sorbent.

2. The method of claim 1, comprising using the compressed recycle exhaust gas stream to cool a combustor in the gas turbine system.

3. The method of claim 2, comprising compressing a gaseous fuel for use in the combustor.

4. The method of claim 1, comprising recovering heat energy from the recycle exhaust gas stream to generate steam in a heat recovery steam generator (HRSG).

5. The method of claim 4, comprising using the generated steam to generate power or facilitate oil recovery in a cyclic steam stimulation system, or both.

6. The method of claim 4, comprising re-generating the solid sorbent using heat from the HRSG.

7. The method of claim 1, comprising using a residual stream of the compressed recycle exhaust gas stream as a diluent in a combustor of the gas turbine system or a coolant for at least a portion of an expander of the gas turbine system, or both.

8. The method of claim 1, wherein a volume of the purge stream extracted from the compressed recycle exhaust gas stream is less than half of a volume of the compressed recycle exhaust gas stream.

9. The method of claim 1, wherein the recycle exhaust gas is compressed to a pressure level above atmospheric pressure.

10. The method of claim 1, wherein removing carbon dioxide from the extracted purge stream comprises adsorbing and/or chemisorbing the carbon dioxide with the solid sorbent.

11. The method of claim 1, wherein removing carbon dioxide from the extracted purge stream using a solid sorbent comprises re-generating the solid sorbent by changing temperature and/or pressure in a chamber that holds the solid sorbent.

12. The method of claim 1, wherein removing carbon dioxide from the extracted purge stream is performed under pressure and/or temperature conditions that favor a carbonation reaction between the extracted purge stream and the solid sorbent.

13. The method of claim 1, wherein the solid sorbent used to remove carbon dioxide from the extracted purge stream comprises calcium, lithium, sodium, or potassium, or any combinations thereof.

14. The method of claim 1, wherein removing the carbon dioxide from the extracted purge stream is performed at a temperature between a range of about 100 degrees Celsius to about 900 degrees Celsius.

15. The method of claim 1, wherein removing the carbon dioxide from the extracted purge stream comprises performance of an exothermic process, the method further comprising using heat generated by the exothermic process to generate steam.

16. The method of claim 1, wherein removing the carbon dioxide from the extracted purge stream comprises performance of an exothermic process, the method further comprising using heat generated by the exothermic process to increase a temperature of a residual stream, substantially depleted of carbon dioxide, of the extracted purge stream.

17. The method of claim 1, comprising injecting the removed carbon dioxide into an oil reservoir to enhance recovery of oil from the oil reservoir.

18. The method of claim 1, comprising, after removing the carbon dioxide, using a residual stream, substantially depleted of carbon dioxide, of the extracted purge stream for pressure maintenance in the combined cycle plant.

19. The method of claim 1, comprising, after removing the carbon dioxide, using a residual stream, substantially depleted of carbon dioxide, of the extracted purge stream in a standalone stoichiometric combustion exhaust gas recirculation application.

20. A system for enhanced carbon dioxide capture in a combined cycle plant, comprising:
a gas turbine system configured to produce a recycle exhaust gas stream as a byproduct of combustion;
a compressor configured to compress the recycle exhaust gas stream, wherein the gas turbine system is further configured to receive the compressed recycle exhaust gas stream and to extract a purge stream from the compressed recycle exhaust gas stream; and
a carbon dioxide separator configured to receive the extracted purge stream from the gas turbine system and to remove carbon dioxide from the extracted purge stream using a solid sorbent.

21. The system of claim 20, comprising:
a heat recovery steam generator (HRSG) configured to recover heat energy from the recycle exhaust gas stream of the gas turbine system to generate steam; and
a steam turbine that is fluidly coupled to the HRSG to receive the generated steam, wherein the steam turbine is configured to generate power with the received steam.

22. The system of claim 21, wherein the carbon dioxide separator is coupled to receive heat from the HRSG and is configured to use the received heat to re-generate the solid sorbent.

23. The system of claim 20, wherein the carbon dioxide separator comprises a first chamber configured to hold the solid sorbent, the carbon dioxide separator being configured to control temperature and/or pressure conditions in the first chamber to favor adsorption and/or chemisorption of carbon dioxide by the solid sorbent.

24. The system of claim 23, wherein the carbon dioxide separator comprises a second chamber configured to hold carbon dioxide-enriched solid sorbent, the carbon dioxide separator being configured to control temperature and/or pressure conditions in the second chamber to re-generate the carbon dioxide-enriched solid sorbent.

25. The system of claim 20, wherein the solid sorbent used to remove the carbon dioxide from the extracted purge stream comprises calcium, lithium, sodium, or potassium, or any combinations thereof.

26. The system of claim 20, comprising a steam generator, wherein the carbon dioxide separator generates heat as part of the process of removing carbon dioxide from the extracted purge stream and the steam generator is configured to use the generated heat to generate steam.

27. The system of claim 20, comprising a heat exchanger, wherein the carbon dioxide separator generates heat as part of the process of removing carbon dioxide from the extracted purge stream and the heat exchanger is configured to use the generated heat to increase a temperature of a residual stream of the extracted purge stream in which the carbon dioxide has been substantially removed.

28. The system of claim 20, comprising another compressor configured to use a residual stream, substantially depleted of carbon dioxide, of the extracted purge stream for pressure maintenance in the combined cycle plant.

29. The system of claim 20, comprising a standalone stoichiometric combustor configured to use a residual stream, substantially depleted of carbon dioxide, of the extracted purge stream for a standalone stoichiometric combustion exhaust gas recirculation application.

30. A system for enhanced carbon dioxide capture in a combined cycle plant, comprising:
a semi-closed Brayton cycle power plant configured to produce a recycle exhaust gas stream as a byproduct of combustion;
a heat recovery steam generator (HRSG) configured to recover heat energy from the recycle exhaust gas stream of a gas turbine system for steam generation and to emit a cooled recycle exhaust gas stream;
a compressor configured to compress the cooled recycle exhaust gas stream, wherein the semi-closed Brayton cycle power plant is further configured to receive the cooled and compressed recycle exhaust gas stream and to extract a purge stream from the cooled and compressed recycle exhaust gas stream; and
a carbon dioxide separator configured to receive the extracted purge stream from the semi-closed Brayton cycle power plant and to remove carbon dioxide from the extracted purge stream using a solid sorbent.

31. The system of claim 30, wherein the carbon dioxide separator is coupled to receive heat from the HRSG and is configured to use the received heat to re-generate the solid sorbent.

32. The system of claim 30, wherein the carbon dioxide separator comprises:
a first chamber configured to hold the solid sorbent, the carbon dioxide separator being configured to control temperature and/or pressure conditions in the first chamber to favor adsorption and/or chemisorption of carbon dioxide by the solid sorbent; and
a second chamber configured to hold carbon dioxide-enriched solid sorbent, the carbon dioxide separator being configured to control temperature and/or pressure conditions in the second chamber to re-generate the carbon dioxide-enriched solid sorbent.

33. The system of claim 30, wherein the carbon dioxide separator generates heat as part of the process of removing carbon dioxide from the extracted purge stream, and wherein the system is configured to use the generated heat to generate steam and/or to increase a temperature of a residual stream of the extracted purge stream in which the carbon dioxide has been substantially removed.
